(19) United States
(12) Patent Application Publication
(10) Pub. No.: US 2026/0032401 A1
(43) Pub. Date: Jan. 29, 2026

(54) INFORMATION PROCESSING DEVICE, INFORMATION PROCESSING METHOD, AND RECORDING MEDIUM

(71) Applicants: Panasonic Holdings Corporation, Osaka (JP); Akita Prefectural University, Akita-shi (JP)

(72) Inventors: Seigo ENOMOTO, Kyoto (JP); Hikaru USAMI, Osaka (JP); Kota NAKAHASHI, Osaka (JP); Tomokazu ISHIKAWA, Osaka (JP); Masayuki NISHIGUCHI, Akita (JP)

(21) Appl. No.: 19/347,121

(22) Filed: Oct. 1, 2025

Related U.S. Application Data
(63) Continuation of application No. PCT/JP2024/014744, filed on Apr. 11, 2024.

(30) Foreign Application Priority Data
Apr. 14, 2023 (JP) 2023-066552

(51) Int. Cl. H04S 7/00

(52) U.S. Cl. CPC H04S 7/305; H04S 2400/11; H04S 2420/01

(57) ABSTRACT

An information processing device includes an obtainer that obtains sound information including an audio signal and information on a position of a sound source object in a three-dimensional sound field; a first generator that generates an output sound signal using (i) a head-related transfer function corresponding to a direction of arrival based on the position of the sound source object and a position of a user in the three-dimensional sound field and (ii) the audio signal; and a second generator that generates an output sound signal using (i) a head-related transfer function corresponding to a representative direction based on a position of a representative point set in the three-dimensional sound field and the position of the user and (ii) the audio signal.

### CROSS REFERENCE TO RELATED APPLICATIONS

This is a continuation application of PCT International Application No. PCT/JP2024/014744 filed on Apr. 11, 2024, designating the United States of America, which is based on and claims priority of Japanese Patent Application No. 2023-066552 filed on Apr. 14, 2023. The entire disclosures of the above-identified applications, including the specifications, drawings, and claims are incorporated herein by reference in their entirety.

### FIELD

The present disclosure relates to an information processing device, an information processing method, and a recording medium.

### BACKGROUND

Techniques for acoustic reproduction to make a user perceive three-dimensional sound in a virtual three-dimensional space are known (see, for example, Patent Literature (PTL) 1). In order to make the sound be perceived as arriving from a sound source object to the user in such a three-dimensional space, processing is required to generate output sound information from the original sound information. In particular, enormous processing is required to reproduce three-dimensional sound in response to the movement of the user's body in a virtual space. In particular, with the development of computer graphics (CG), it has become possible to construct visually complex virtual environments relatively easily, and technology for realizing corresponding auditory information has become important. In addition, when processing from sound information to output sound information is performed in advance, a large memory area for storing the pre-calculated processing results is required. When transmitting such large processing result data, a wide communication bandwidth may be required.

In order to achieve a sound environment that more closely resembles reality, the number of objects that produce sound in a virtual three-dimensional space increases, acoustic effects such as reflected sound, diffracted sound, and reverberation increase, and furthermore, these acoustic effects need to be appropriately changed in response to the movement of the user, requiring a large amount of processing. As a means to reduce such large amounts of processing, a conversion technique called panning processing is known. Panning processing expresses sound in a three-dimensional space by way of sound from several representative points that are set in advance in the three-dimensional space.

### CITATION LIST

### Patent Literature

PTL 1: Japanese Unexamined Patent Application Publication No. 2020-18620

### SUMMARY

### Technical Problem

However, with conversion processing such as panning processing, there may be cases where it is not effective in reducing the amount of processing. In view of this, the present disclosure provides an information processing device and the like for applying conversion processing effectively.

### Solution to Problem

An information processing device according to one aspect of the present disclosure includes: an obtainer that obtains sound information including an audio signal and information on a position of a sound source object in a three-dimensional sound field; a first generator that generates an output sound signal using (i) a head-related transfer function corresponding to a direction of arrival and (ii) the audio signal, the direction of arrival being based on the position of the sound source object and a position of a user in the three-dimensional sound field; and a second generator that generates an output sound signal using (i) a head-related transfer function corresponding to a representative direction and (ii) the audio signal, the representative direction being based on a position of a representative point set in the three-dimensional sound field and the position of the user.

An information processing device according to another aspect of the present disclosure includes: storage that stores a time shift adjustment amount and a gain adjustment amount in association with each of a plurality of directions; an obtainer that obtains an audio signal and information on a position of a sound source object in a three-dimensional sound field; and a second generator that generates an output sound signal as sound arriving at a position of a user in the three-dimensional sound field from a second direction, using (i) the audio signal and (ii) the time shift adjustment amount and the gain adjustment amount corresponding to a first direction based on the position of the sound source object and the position of the user.

An information processing method according to one aspect of the present disclosure is executed by a computer to generate an output sound signal as a sound arriving from a sound source object in a virtual three-dimensional sound field by processing sound information, and includes: obtaining a position of the sound source object and an audio signal including reproduced sound emitted from the sound source object based on the audio signal; obtaining a position of a user in the three-dimensional sound field; calculating a direction of arrival of the reproduced sound arriving at the position of the user from the position of the sound source object; generating the output sound signal using (i) a head-related transfer function corresponding to the direction of arrival calculated and (ii) the reproduced sound; and generating the output sound signal using (i) a head-related transfer function corresponding to a representative direction and (ii) the audio signal, the representative direction being based on a position of a representative point set in the three-dimensional sound field and the position of the user.

One aspect of the present disclosure may be realized as a non-transitory computer-readable storage medium for use in a computer, the storage medium having a computer program recorded thereon for causing the computer to execute the information processing method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure makes it possible to apply conversion processing effectively.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an example of use of an acoustic reproduction system according to an embodiment of the present disclosure.

FIG. 2 is a block diagram illustrating the functional configuration of an acoustic reproduction system according to an embodiment of the present disclosure.

FIG. 3 is a block diagram illustrating the functional configuration of an obtainer according to an embodiment of the present disclosure.

FIG. 4 is a block diagram illustrating the functional configuration of an output sound generator according to an embodiment of the present disclosure.

FIG. 5 is a flowchart illustrating a first operation example of an information processing device according to an embodiment of the present disclosure.

FIG. 6 is a flowchart illustrating a second operation example of an information processing device according to an embodiment.

FIG. 7 is a diagram for explaining a processing target of panning processing according to an embodiment of the present disclosure.

FIG. 8 is a flowchart illustrating a third operation example of an information processing device according to an embodiment.

### Description of Embodiments

### Underlying Knowledge Forming Basis of the Disclosure

Techniques for acoustic reproduction to make a user perceive three-dimensional sound in a virtual three-dimensional space (hereinafter may be referred to as a three-dimensional sound field) are known (see, for example, PTL 1). By using this technique, the user can perceive the sound as if a sound source object is at a predetermined position in the virtual space and the sound is arriving from that direction. In order to localize a sound image at a predetermined position in a virtual three-dimensional space in this way, for example, computational processing is required to generate interaural time differences and interaural level differences (or sound pressure differences) between the ears for the signal of the sound that the sound source object is producing (also referred to as sound emitted from the sound source object, or reproduced sound), such that the sound is perceived as a three-dimensional sound. Such computational processing is performed by applying a three-dimensional sound filter. A three-dimensional sound filter is an information processing filter that, when applied to the original sound information and the resulting output sound signal is reproduced, allows the direction and distance of the sound, the size of the sound source, and the spaciousness to be perceived three-dimensionally.

As one example of computational processing for applying such a three-dimensional sound filter, processing that convolves a head-related transfer function for perceiving sound as arriving from a predetermined direction with the signal of the target sound is known. Performing the convolution processing of this head-related transfer function at sufficiently fine angles with respect to the direction of arrival of the reproduced sound from the position of the sound source object to the user's position enhances the sense of realism experienced by the user.

In recent years, development of technology related to virtual reality (VR) has been actively conducted. In virtual reality, the position of sound objects in a virtual three-dimensional space appropriately changes in response to the user's movement, with the main focus being on allowing the user to physically experience as if they are moving within the virtual space. For this purpose, it is necessary to relatively move the localization position of the sound image in the virtual space in response to the user's movement. Such processing has been performed by applying a three-dimensional sound filter, such as the head-related transfer function mentioned above, to the original sound information. However, when a user moves in a three-dimensional space, the sound transmission path changes from moment to moment according to each positional relationship between the sound source object and the user, including sound reverberation and interference. As a result, if the sound transmission path from the sound source object is determined based on the positional relationship between the sound source object and the user each time, and the transfer function is convolved considering sound reverberation and interference each time, the information processing becomes enormous, and without a large-scale processing device, it may not be possible to achieve an improvement in the sense of realism.

As a means to reduce such enormous processing amounts, attempts have been made to apply panning processing to the reproduced sound to reduce the amount of convolution of the head-related transfer function. More specifically, for each of the many sound source objects in the three-dimensional space, rather than convolving the head-related transfer function with the reproduced sound, the reproduced sound from the sound source object is re-expressed by sounds (representative sounds) from several representative points that are preset in the three-dimensional space. It becomes possible to cause the user to perceive three-dimensional sound without any noticeable difference simply by convolving the head-related transfer function from the representative point to the user's position with the representative sound. If the number of representative points is less than the number of original sound source objects, naturally, the number of targets for which the head-related transfer function convolution is performed also decreases, which is advantageous from the perspective of processing amount.

However, when applying such panning processing, under certain conditions such as when there are few original sound source objects, the overall processing amount reduction effect may not be achieved due to the increase in processing amount of the panning processing itself. In view of this, the present disclosure provides an information processing device that includes two types of processors for generating output sound signals so that both cases, i.e., where panning processing is applied and where it is not applied, are possible. This makes it possible to generate output sound signals with panning processing applied if panning processing is effective in reducing the amount of processing, and to generate output sound signals without applying panning processing if it is not. In other words, it becomes possible to apply conversion processing such as panning processing effectively.

A more specific overview of the present disclosure is as follows.

An information processing device according to a first aspect of the present disclosure includes: an obtainer that obtains sound information including an audio signal and information on a position of a sound source object in a three-dimensional sound field; a first generator that generates an output sound signal using (i) a head-related transfer function corresponding to a direction of arrival and (ii) the audio signal, the direction of arrival being based on the position of the sound source object and a position of a user in the three-dimensional sound field; and a second generator that generates an output sound signal using (i) a head-related transfer function corresponding to a representative direction and (ii) the audio signal, the representative direction being based on a position of a representative point set in the three-dimensional sound field and the position of the user.

With such an information processing device, it is possible to generate an output sound signal using a head-related transfer function corresponding to a direction of arrival calculated using the first generator, and to generate an output sound signal using a head-related transfer function corresponding to a representative direction using the second generator. For example, the second generator can be used when doing so would effectively reduce the processing load; otherwise, the first generator can be used. Stated differently, from the perspective of processing load, effective application of conversion processing can be achieved through methods such as conditional branching.

An information processing device according to a second aspect is the information processing device according to the first aspect, wherein the first generator generates the output sound signal by convolving the head-related transfer function corresponding to the direction of arrival with reproduced sound emitted from the sound source object based on the audio signal, and the second generator generates the output sound signal by performing conversion processing that converts the reproduced sound into representative sound arriving from the representative point, and convolving the head-related transfer function corresponding to the representative direction.

With this, the first generator generates the output sound by convolving the head-related transfer function signal corresponding to the direction of arrival with the reproduced sound, and the second generator can generate the output sound signal that expresses sound from the direction of arrival by way of representative sound arriving from each of representative points set in the three-dimensional sound field through conversion processing such as panning processing. For example, the second generator can be used when applying conversion processing would effectively reduce the processing load; otherwise, the first generator can be used. Stated differently, from the perspective of processing load, effective application of conversion processing can be achieved through methods such as conditional branching.

An information processing device according to a third aspect is the information processing device according to the second aspect, wherein in the conversion processing, the reproduced sound is converted into the representative sound by applying time shift adjustment and gain adjustment to the reproduced sound.

With this, in the conversion processing, the reproduced sound can be converted into the representative sound by applying time shift adjustment and gain adjustment to the reproduced sound. As a result, even when conversion processing is applied, a sense of discomfort is reduced, and an output sound signal with a higher sense of realism can be generated.

An information processing device according to a fourth aspect is the information processing device according to any one of the first to third aspects, wherein the sound source object includes a plurality of sound source objects, the sound information includes positions of each of the plurality of sound source objects and reproduced sound emitted from each of the plurality of sound source objects based on the audio signal, and a total number of representative points, each being the representative point, is determined based on a total number of the plurality of sound source objects.

With this, the number of representative points can be dynamically changed based on the number of sound source objects, and appropriate conversion processing can be performed each time.

An information processing device according to a fifth aspect is the information processing device according to the fourth aspect, wherein the total number of representative points is less than the total number of the plurality of sound source objects.

With this, the number of representative points can be dynamically changed based on the number of sound source objects, and appropriate conversion processing can be performed each time. In particular, having fewer representative points than the number of sound source objects achieves greater efficiency in reducing the amount of processing during the conversion processing.

An information processing device according to a sixth aspect is the information processing device according to the third aspect, wherein in the time shift adjustment in the conversion processing, one of the following is applied to the reproduced sound: a time shift calculated to maximize a cross-correlation between the head-related transfer function corresponding to the direction of arrival and the head-related transfer function corresponding to the representative direction; or a time shift with a negative sign added to the time shift calculated.

With this, time shift adjustment can be performed on the reproduced sound by applying either a time shift calculated to maximize a cross-correlation between the head-related transfer function corresponding to the direction of arrival and the head-related transfer function corresponding to the representative direction, or a time shift with a negative sign added to calculate the time shift.

An information processing device according to a seventh aspect is the information processing device according to the sixth aspect, wherein in the conversion processing, at least one of the time shift adjustment or the gain adjustment applies a time shift calculated to maximize the cross-correlation after applying a frequency-domain weighting filter, or a time shift with a negative sign added to the time shift calculated.

With this, at least one of the time shift adjustment or the gain adjustment can be performed by applying either a time shift calculated to maximize the cross-correlation after applying a frequency-domain weighting filter, or a time shift with a negative sign added to the calculated time shift.

An information processing device according to an eighth aspect is the information processing device according to the sixth aspect, wherein the representative point and the representative direction respectively include a plurality of representative points and a plurality of representative directions, and in the conversion processing, for each of two or more of the plurality of representative points, a gain that is set for the reproduced sound and for each of the plurality of representative directions is applied to the reproduced sound applied with the time shift.

With this, for each of two or more representative points, conversion processing can be performed by applying a gain that is set for each reproduced sound direction of arrival and each representative direction to the reproduced sound applied with the time shift.

An information processing device according to a ninth aspect is the information processing device according to the eighth aspect, wherein in the conversion processing, when synthesizing a head-related transfer function vector corresponding to the direction of arrival using a sum of head-related transfer function vectors corresponding to the plurality of representative directions, a gain is used that is so calculated that an error signal vector between the head-related transfer function vector synthesized and the head-related transfer function vector corresponding to the direction of arrival is orthogonal to the head-related transfer function vectors corresponding to the plurality of representative directions.

With this, in the conversion processing, when synthesizing a head-related transfer function vector corresponding to the direction of arrival using a sum of head-related transfer function vectors corresponding to the representative directions, a gain is used that is so calculated that the error signal vector between the synthesized head-related transfer function vector and the head-related transfer function vector corresponding to the direction of arrival is orthogonal to the head-related transfer function vectors corresponding to the representative directions.

An information processing device according to a tenth aspect is the information processing device according to the eighth aspect, wherein in the conversion processing, a gain is used that is calculated to minimize energy or L2 norm of an error signal vector between a synthesized head-related transfer function vector and a head-related transfer function vector corresponding to the direction of arrival.

With this, conversion processing can be performed using a gain calculated to minimize energy or L2 norm of an error signal vector between a synthesized head-related transfer function vector and a head-related transfer function vector of the direction of arrival.

An information processing device according to an eleventh aspect is the information processing device according to the tenth aspect, wherein the error signal vector is one to which a frequency-domain weighting filter has been applied.

With this, as the error signal vector, one to which a frequency-domain weighting filter has been applied can be used.

An information processing device according to a certain aspect is the information processing device according to the third aspect, wherein when the information processing device loads a new head-related transfer function that is not stored in a storage for storing head-related transfer functions, the information processing device determines adjustment amounts for time shift adjustment and gain adjustment to be used in conversion processing for the new head-related transfer function, the loaded new head-related transfer function with the determined adjustment amounts and stores them in a database, and in the conversion processing, converts the reproduced sound into representative sound by applying time shift adjustment and gain adjustment to the reproduced sound using the adjustment amounts associated with the new head-related transfer function stored in the storage.

With this, when a new head-related transfer function that is not stored in a storage for storing head-related transfer functions is loaded, adjustment amounts for time shift adjustment and gain adjustment to be used in conversion processing can be determined for the new head-related transfer function, the loaded new head-related transfer function and the determined adjustment amounts can be associated and stored in the storage, and this can be used in conversion processing. The new head-related transfer function has adjustment amounts suitable for that head-related transfer function, and by determining such adjustment amounts before starting conversion processing (for example, when decoding the sound signal, at power-on of the acoustic reproduction system, or at initialization of the acoustic reproduction system, etc.), conversion processing with appropriate adjustment amounts can be performed while inhibiting an increase in processing amount.

An information processing device according to a twelfth aspect is the information processing device according to the third aspect, wherein the information processing device stores an adjustment amount table into storage at initialization, the adjustment amount table associating, for each head-related transfer function direction, a head-related transfer function of a representative direction with adjustment amounts for the time shift adjustment and the gain adjustment to be used in the conversion processing, and in the conversion processing, the reproduced sound is converted into the representative sound by applying the time shift adjustment and the gain adjustment to the reproduced sound using, from the adjustment amount table stored in the storage, the adjustment amounts associated with each head-related transfer function direction corresponding to the representative direction.

With this, in the conversion processing, the representative sound can be converted by applying the time shift adjustment and the gain adjustment using, from the adjustment amount table stored in the storage at initialization, the adjustment amounts associated with each head-related transfer function direction corresponding to the representative direction.

An information processing device according to a thirteenth aspect is the information processing device according to the twelfth aspect, wherein at the initialization, the information processing device determines a plurality of representative directions each of which is the representative direction, and the adjustment amount table is created based on head-related transfer functions of the plurality of representative directions determined.

With this, in the conversion processing, the representative sound can be converted by applying the time shift adjustment and the gain adjustment using the adjustment amounts associated with each head-related transfer function direction created based on the determined plurality of representative directions.

An information processing device according to a fourteenth aspect is the information processing device according to any one of the first to thirteenth aspects, wherein the sound information includes a flag that specifies whether to generate the output sound signal using the first generator or to generate the output sound signal using the second generator, and the information processing device generates the output sound signal using one of the first generator or the second generator that is specified by the flag included in the sound information obtained.

With this, the output sound signal can be generated using the one of the first generator or the second generator that is specified by the flag included in the sound information. Stated differently, which one of the first generator or the second generator to use can be specified by the flag.

An information processing device according to a fifteenth aspect is the information processing device according to any one of the first to fourteenth aspects, further including: a switcher that switches between generating the output sound signal using the first generator or generating the output sound signal using the second generator.

With this, it is possible to switch between generating the output sound signal using the first generator or generating the output sound signal using the second generator.

An information processing device according to a sixteenth aspect is the information processing device according to the fifteenth aspect, wherein the switcher: compares a total number of sound source objects, each of which is the sound source object, included in the sound information with a total number of representative points, each of which is the representative point, set in the three-dimensional sound field; and switches between generating the output sound signal using the first generator or generating the output sound signal using the second generator according to a comparison result.

With this, the switcher can appropriately switch between generating the output sound signal using the first generator or generating the output sound signal using the second generator by comparing the number of sound source objects included in the sound information with the number of representative points set in the three-dimensional sound field.

An information processing device according to a seventeenth aspect is the information processing device according to the fifteenth aspect, wherein the switcher switches to generating the output sound signal using the first generator when a head-related transfer function stored in storage for storing head-related transfer functions does not satisfy a predetermined condition.

With this, the switcher can switch to generating the output sound signal using the first generator when a head-related transfer function in the storage does not satisfy a predetermined condition.

An information processing device according to an eighteenth aspect is the information processing device according to any one of the first to seventeenth aspects, further including: a route calculator that calculates a propagation route of reproduced sound emitted from the sound source object based on the audio signal, and calculates (i) a synthesized sound arriving at the position of the user by indirect propagation of the reproduced sound according to the propagation route of the reproduced sound calculated, and (ii) a direction of arrival of the synthesized sound.

With this, the route calculator can calculate a propagation route of reproduced sound from the sound source object, and calculate a synthesized sound arriving at the position of the user by indirect propagation of the reproduced sound according to the calculated propagation route of the reproduced sound and the direction of arrival of the synthesized sound.

An information processing device according to a nineteenth aspect is the information processing device according to the eighteenth aspect, further including: a switcher that switches between generating the output sound signal using the first generator or generating the output sound signal using the second generator, wherein the switcher individually switches between generating the output sound signal using the first generator or generating the output sound signal using the second generator for each of the reproduced sound and the synthesized sound.

With this, it is possible to individually switch between generating the output sound signal using the first generator or generating the output sound signal using the second generator for each of the reproduced sound and the synthesized sound.

An information processing device according to a twentieth aspect is the information processing device according to the eighteenth aspect, further including: a switcher that switches between generating the output sound signal using the first generator or generating the output sound signal using the second generator, wherein the route calculator calculates two or more synthesized sounds, each of which is the synthesized sound, arriving at the position of the user by different indirect propagations, and directions of arrival of the two or more synthesized sounds, and the switcher individually switches between generating the output sound signal using the first generator or generating the output sound signal using the second generator for each of the two or more synthesized sounds.

With this, the route calculator calculates two or more synthesized sounds arriving at the position of the user by different indirect propagations and directions of arrival of the two or more synthesized sounds, and it is possible to individually switch between generating the output sound signal using the first generator or generating the output sound signal using the second generator for each of the two or more synthesized sounds.

An information processing device according to a twenty-first aspect is the information processing device according to the eighteenth aspect, further including: a switcher that switches between generating the output sound signal using the first generator or generating the output sound signal using the second generator, wherein the switcher: compares a sum total number of reproduced sounds, each of which is the reproduced sound, and synthesized sounds, each of which is the synthesized sound, with a total number of representative points, each of which is the representative point, set in the three-dimensional sound field; and switches between generating the output sound signal using the first generator or generating the output sound signal using the second generator according to a comparison result.

With this, it is possible to switch between generating the output sound signal using the first generator or generating the output sound signal using the second generator by comparing the total number of the reproduced sound and the synthesized sound with the number of representative points set in the three-dimensional sound field.

An information processing method according to a twenty-second aspect is executed by a computer to generate an output sound signal as a sound arriving from a sound source object in a virtual three-dimensional sound field by processing sound information, and includes: obtaining a position of the sound source object and an audio signal including reproduced sound emitted from the sound source object based on the audio signal; obtaining a position of a user in the three-dimensional sound field; calculating a direction of arrival of the reproduced sound arriving at the position of the user from the position of the sound source object; generating the output sound signal using (i) a head-related transfer function corresponding to the direction of arrival calculated and (ii) the reproduced sound; and generating the output sound signal using (i) a head-related transfer function corresponding to a representative direction and (ii) the audio signal, the representative direction being based on a position of a representative point set in the three-dimensional sound field and the position of the user.

According to this, advantageous effects similar to those of the information processing device described above can be achieved.

A recording medium according to a twenty-third aspect is a non-transitory computer-readable recording medium for use in a computer, the recording medium having a computer program recorded thereon for causing the computer to execute the information processing method described above.

According to this, advantageous effects similar to those of the information processing method described above can be achieved using a computer.

An information processing device according to another aspect is an information processing device that generates an output sound signal as a sound arriving from a sound source object in a virtual three-dimensional sound field by processing sound information using head-related transfer functions, and includes: a sound obtainer that obtains sound information including a position of the sound source object and reproduced sound emitted from the sound source object; a position obtainer that obtains a position of a user in the three-dimensional sound field; a direction of arrival calculator that calculates a relative direction of arrival of the reproduced sound arriving at the position of the user from the position of the sound source object; and a third generator, wherein when a new head-related transfer function that is not stored in a storage for storing head-related transfer functions is loaded, before storing it in the storage, adjustment amounts for time shift adjustment and gain adjustment to be used in conversion processing are determined for the new head-related transfer function, the loaded new head-related transfer function and the determined adjustment amounts are associated and stored in the storage, and the third generator applies time shift adjustment and gain adjustment to the reproduced sound using the adjustment amounts associated with the new head-related transfer function stored in the storage to convert it into representative sound, and generates the output sound signal by transfer functions corresponding to convolving head-related representative directions from the positions of each representative point toward the position of the user onto the representative sound.

With this, when a new head-related transfer function that is not stored in a storage for storing head-related transfer functions is loaded, adjustment amounts for time shift adjustment and gain adjustment to be used in conversion processing such as panning processing can be determined for the new head-related transfer function, the loaded new head-related transfer function and the determined adjustment amounts can be associated and stored in the storage, and this can be used in conversion processing. The new head-related transfer function has adjustment amounts suitable for that head-related transfer function, and by determining such adjustment amounts before starting conversion processing (for example, when decoding the sound signal, at power-on of the acoustic reproduction system, or at initialization of the acoustic reproduction system, etc.), conversion processing with appropriate adjustment amounts can be performed while inhibiting an increase in processing amount.

An information processing device according to a twenty-fourth aspect of the present disclosure includes: storage that stores a time shift adjustment amount and a gain adjustment amount in association with each of a plurality of directions; an obtainer that obtains an audio signal and information on a position of a sound source object in a three-dimensional sound field; and a second generator that generates an output sound signal as sound arriving at a position of a user in the three-dimensional sound field from a second direction, using (i) the audio signal and (ii) the time shift adjustment amount and the gain adjustment amount corresponding to a first direction based on the position of the sound source object and the position of the user.

With this, by storing a time shift adjustment amount and a gain adjustment amount in association with each of a plurality of directions, an output sound signal can be generated as sound arriving at a position of a user from a second direction while inhibiting an increase in processing load by using appropriate adjustment amounts, using the obtained audio signal and the time shift adjustment amount and the gain adjustment amount corresponding to a first direction based on the position of the sound source object and the position of the user in the three-dimensional sound field.

An information processing device according to a twenty-fifth aspect is the information processing device according to the twenty-fourth aspect, wherein the storage further stores a head-related transfer function corresponding to the second direction, and the second generator generates the output sound signal as sound arriving at the position of the user from the second direction using (i) the audio signal, (ii) the time shift adjustment amount and the gain adjustment amount corresponding to the first direction, and (iii) the head-related transfer function corresponding to the second direction.

With this, by further holding an auxiliary storage or the like that includes a head-related transfer function corresponding to the second direction and storing such information, the output sound signal can be generated as sound arriving at the position of the user from the second direction using the time shift adjustment amount and the gain adjustment amount corresponding to the first direction and the head-related transfer function corresponding to the second direction.

An information processing device according to a twenty-sixth aspect is the information processing device according to the twenty-fourth aspect, wherein the storage further stores a head-related transfer function corresponding to the second direction and head-related transfer functions corresponding to directions other than the second direction, the second generator generates the output sound signal as sound arriving at the position of the user from the second direction using (i) the audio signal, (ii) the time shift adjustment amount and the gain adjustment amount corresponding to the first direction, and (iii) the head-related transfer function corresponding to the second direction, the information processing device further includes a first generator, and the first generator generates an audio signal as sound arriving at the position of the user from the first direction using (i) the audio signal and (ii) a head-related transfer function corresponding to the first direction.

With this, by the storage further holding an auxiliary storage or the like that includes head-related transfer functions corresponding to the second direction and directions other than the second direction and storing such information, the second generator can generate the output sound signal as sound arriving at the position of the user from the second direction using (i) the audio signal, (ii) the time shift adjustment amount and the gain adjustment amount corresponding to the first direction, and (iii) the head-related transfer function corresponding to the second direction. Further, the information processing device includes a first generator, and the first generator can generate an audio signal as sound arriving at the position of the user from the first direction using (i) the audio signal and (ii) the head-related transfer function corresponding to the first direction. For example, the second generator can be used when executing processing using the time shift adjustment amount and gain adjustment amount would effectively reduce the processing load; otherwise, the first generator can be used. Stated differently, from the perspective of processing load, effective application of conversion processing can be achieved through methods such as conditional branching.

An information processing method according to yet another aspect holds auxiliary storage that stores a time shift adjustment amount and a gain adjustment amount in association with each of a plurality of directions, obtains an audio signal and information on a position of a sound source object in a three-dimensional sound field, and generates an output sound signal as sound arriving at a position of a user from a second direction, using (i) the audio signal and (ii) the time shift adjustment amount and the gain adjustment amount corresponding to a first direction based on the position of the sound source object and the position of the user.

According to this, advantageous effects similar to those of the information processing device according to the twenty-third aspect can be achieved.

A recording medium according to yet another aspect is a non-transitory computer-readable recording medium for use in a computer, the recording medium having a computer program recorded thereon for causing the computer to execute an information processing method according to the yet another aspect above.

According to this, advantageous effects similar to those of the information processing method according to the yet another aspect above can be achieved using a computer.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments will be described in detail with reference to the drawings. Each embodiment described below presents a general or specific example. The numerical values, shapes, materials, elements, the arrangement and connection of the elements, steps, the processing order of the steps etc., shown in the following embodiment are mere examples, and do not limit the scope of the present disclosure. Among the elements described in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, ordinal numbers such as first, second, and third may be given to elements. These ordinal numbers are given to elements in order to distinguish between the elements, and thus do not necessarily correspond to an order that has intended meaning. Such ordinal numbers may be switched as appropriate, new ordinal numbers may be given, or the ordinal numbers may be removed.

### Embodiment

### Overview

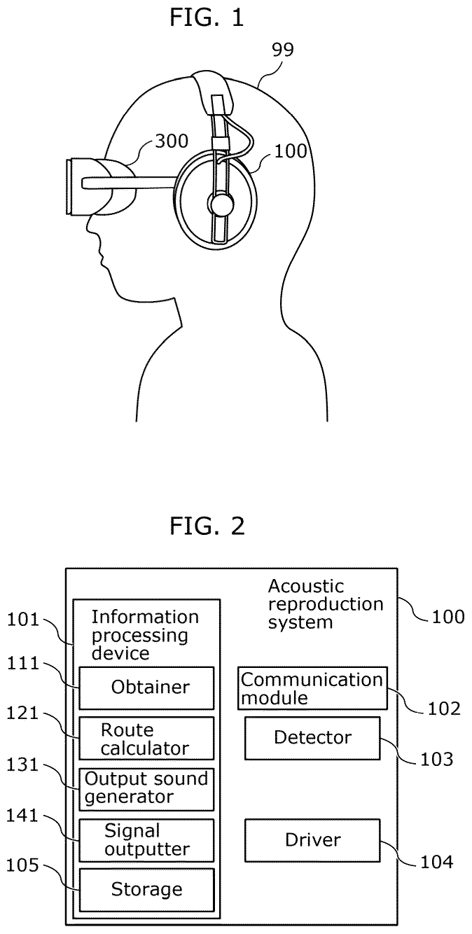

First, an overview of an acoustic reproduction system according to an embodiment will be described. FIG. 1 is a schematic diagram illustrating an example of use of an acoustic reproduction system according to the embodiment. FIG. 1 illustrates user 99 using acoustic reproduction system 100.

Acoustic reproduction system 100 illustrated in FIG. 1 is used simultaneously with stereoscopic image reproduction device 300. By simultaneously viewing stereoscopic images and listening to three-dimensional sound, the images enhance the auditory sense of realism, and the sound enhances the visual sense of realism, allowing one to experience as if being at the scene where the images and sound were captured. For example, when an image (moving image) of people having a conversation is displayed, even if the localization of the sound image (sound source object) of the conversation sound is misaligned with the person's mouth, it is known that user 99 perceives it as conversation sound emitted from the person's mouth. In this manner, by combining images and sound, the position of the sound image may be corrected by visual information, thereby enhancing the sense of realism.

Stereoscopic image reproduction device 300 is an image display device worn on the head of user 99. Accordingly, stereoscopic image reproduction device 300 moves integrally with the head of user 99. For example, stereoscopic image reproduction device 300 is, as illustrated in the figure, a glasses-type device supported by the ears and nose of user 99.

Stereoscopic image reproduction device 300 changes the image to be displayed in response to the movement of the head of user 99, to cause user 99 to perceive as if he or she is moving their head within a three-dimensional image space. Stated differently, when an object within the three-dimensional image space is positioned in front of user 99, if user 99 turns to the right, the object moves to the left direction of user 99, and if user 99 turns to the left, the object moves to the right direction of user 99. Thus, stereoscopic image reproduction device 300 moves the three-dimensional image space in the opposite direction to the movement of user 99.

Stereoscopic image reproduction device 300 displays two images, each with a parallax shift, one to the left eye and the other to the right eye of user 99. User 99 can perceive the three-dimensional position of an object in the image based on the parallax shift of the displayed image. Note that when acoustic reproduction system 100 is used for the reproduction of healing sounds to induce sleep, or when user 99 uses it with their eyes closed, stereoscopic image reproduction device 300 does not need to be used simultaneously. Stated differently, stereoscopic image reproduction device 300 is not an essential element of the present disclosure. In addition to dedicated image display devices, there are cases where general-purpose portable terminals such as smartphones and tablet devices owned by user 99 are used for stereoscopic image reproduction device 300.

Such general-purpose portable terminals include various sensors for detecting the posture and movement of the terminal, in addition to a display for displaying images. Such general-purpose portable terminals also include a processor for information processing, enabling connection to a network for sending and receiving information with server devices such as cloud servers. Stated differently, stereoscopic image reproduction device 300 and acoustic reproduction system 100 can also be implemented by a combination of a smartphone and general-purpose headphones without information processing functions.

As in this example, the function for detecting head movement, the function for presenting images, the image information processing function for presentation, the function for presenting sound, and the sound information processing function for presentation may be appropriately arranged in one or more devices to implement stereoscopic image reproduction device 300 and acoustic reproduction system 100. When stereoscopic image reproduction device 300 is unnecessary, it suffices to appropriately arrange the function for detecting head movement, the function for presenting sound, and the sound information processing function for presentation in one or more devices. For example, acoustic reproduction system 100 can also be implemented by a processing device such as a computer or smartphone that includes the sound information processing function for presentation, and headphones or the like that include the function for detecting head movement and the function for presenting sound.

Acoustic reproduction system 100 is an audio presentation device worn on the head of user 99. Accordingly, acoustic reproduction system 100 moves integrally with the head of user 99. For example, acoustic reproduction system 100 according to the present embodiment is what is known as an over-ear headphone device. Note that the embodiment of acoustic reproduction system 100 is not particularly limited and may be, for example, two in-ear devices independently worn on the left and right ears of user 99.

Acoustic reproduction system 100 changes the sound to be presented in response to the movement of the head of user 99, to cause user 99 to perceive as if he or she is moving their head within a three-dimensional sound field. Thus, as described above, acoustic reproduction system 100 moves the three-dimensional sound field in the opposite direction to the movement of user 99.

Here, when user 99 moves within the three-dimensional sound field, the position of the sound source object relative to the position of user 99 in the three-dimensional sound field changes. As a result, it is necessary to generate output sound signals for reproduction by performing calculation processing based on the position of the sound source object and user 99 each time user 99 moves. Since such processing normally requires an enormous amount of processing, in the present disclosure, from the perspective of reducing the amount of processing, panning processing, which is one example of conversion processing, is applied to express the reproduced sound by way of representative sound from a representative point. As a result, it becomes possible to cause user 99 to perceive reproduced sound from the sound source object simply by convolving the head-related transfer function with the representative sound. Hereinafter, in the present embodiment, panning processing will be described as one example of conversion processing. However, the conversion processing is not limited to panning processing; any type of conversion processing that can potentially reduce processing load based on certain conditions may be applied.

If there are fewer representative points preset in the three-dimensional sound field than sound source objects, the required head-related transfer function convolution processing decreases, thereby reducing the overall processing load. However, panning processing adds computational steps not needed when applying the head-related transfer function directly to the original reproduced sound. Therefore, this method only reduces processing load when the number of sound source objects is several times greater than the number of representative points. Additionally, since certain conditions must be met to achieve processing load reduction, when processing load reduction is not anticipated, the present disclosure performs output sound signal generation in normal mode where the head-related transfer function is convolved with the reproduced sound.

### Structure

Next, a configuration of acoustic reproduction system 100 according to the present embodiment will be described with reference to FIG. 2. FIG. 2 is a block diagram illustrating the functional configuration of an acoustic reproduction system according to the embodiment.

As illustrated in FIG. 2, acoustic reproduction system 100 according to the present embodiment includes information processing device 101, communication module 102, detector 103, and driver 104.

Information processing device 101 is a computing device for executing various types of signal processing in acoustic reproduction system 100. Information processing device 101 includes a processor and memory, such as in a computer, and is implemented by the processor executing a program stored in the memory. The functions related to each functional element described below are realized by executing this program.

Information processing device 101 includes obtainer 111, route calculator 121, output sound generator 131, signal outputter 141, and storage 105. Each functional element included in information processing device 101 will be described in detail below along with details regarding configurations other than information processing device 101.

Communication module 102 is an interface device for receiving input of sound information to acoustic reproduction system 100. For example, communication module 102 includes an antenna and a signal converter, and receives sound information from an external device via wireless communication. Communication module 102 may receive a set of head-related transfer functions such as SOFA files from an external device. More specifically, communication module 102 receives, via the antenna, a wireless signal indicating sound information converted into a format for wireless communication, and reconverts the wireless signal into sound information using the signal converter. In this way, acoustic reproduction system 100 obtains sound information and a set of head-related transfer functions from the external device via wireless communication. The sound information and set of head-related transfer functions obtained by communication module 102 are obtained by obtainer 111. In this way, obtainer 111 is one example of a sound obtainer. The sound information is input to information processing device 101 as described above. Communication between acoustic reproduction system 100 and the external device may be wired communication.

Sound information obtained by acoustic reproduction system 100 includes information (a sound signal) about reproduced sound that is reproduced by acoustic reproduction system 100 and information about a localization position when the sound image of the sound is localized at a predetermined position in a three-dimensional sound field (i.e., the sound is perceived as arriving from a predetermined direction). Information about the reproduced sound may be, for example, a sound signal encoded in a predetermined format such as MPEG-H 3D Audio (ISO/IEC 23008-3), or may be a PCM signal that is not encoded. Information about the localization position can also be interpreted as information about the sound source object. Stated differently, the sound information includes a position of the sound source object in the three-dimensional sound field and sound produced by the sound source object. The sound information may include a flag for determining whether to apply panning processing. This flag will be described later.

The sound information is obtained as input data as described above, and includes an audio signal (acoustic signal), which is information about reproduced sound, and information about the position of the sound source object in the three-dimensional sound field, which is other information. The other information may include information for defining the three-dimensional sound field. Therefore, there may be cases where the other information is collectively referred to as information related to space (spatial information), which includes information about the position of the sound source object and information for defining the three-dimensional sound field. When viewed from the perspective of the audio signal, the input data can be said to be sound information in which other information (metadata) is attached to the audio signal. When viewed from the perspective of the spatial information, the input data can be said to be information in which the audio signal is attached to the spatial information. Alternatively, the input data may be considered as sound space information, as it encompasses both of these aspects.

As one specific example, the sound information includes information related to a plurality of sounds including a first reproduced sound and a second reproduced sound, and the sound images are localized so that when each sound is reproduced, they are perceived as sounds arriving from different positions in a three-dimensional sound field. Therefore, the sound source object of the first reproduced sound is localized at a first position in the three-dimensional sound field, and the sound source object of the second reproduced sound is localized at a second position in the three-dimensional sound field. In this way, the sound information may include a plurality of sounds.

The three-dimensional sound, for example, combined with images visually recognized using stereoscopic image reproduction device 300, can enhance the sense of realism of viewed and listened content. Note that the sound information may include only information about the reproduced sound. In such cases, information related to the predetermined position may be separately obtained. As described above, the sound information includes first sound information related to the first reproduced sound and second sound information related to the second reproduced sound, but a plurality of items of sound information separately including these may be obtained respectively and simultaneously reproduced to localize sound images at different positions in the three-dimensional sound field. Thus, the form of the input sound information is not particularly limited, and acoustic reproduction system 100 may include obtainer 111 corresponding to various forms of sound information.

Note that the sound information immediately after being obtained includes an audio signal related to direct sound, and is converted into sound information including audio signals of reverberation sound, primary reflected sound, diffracted sound, and the like by conversion processing that calculates secondary sounds. Alternatively, in addition to the sound information including an audio signal related to direct sound, sound information including an audio signal related to such secondary sound may be obtained. In the conversion processing that adds secondary sound to sound information by calculation, information on the conditions of the spatial environment of the three-dimensional sound field (for example, position of objects in the three-dimensional sound field, reflection, diffraction characteristics, etc.) is used. Thus, secondary sound is computationally generated from sound information related to one reproduced sound, based on the conditions of the spatial environment of the three-dimensional sound field. From one secondary sound, another secondary sound may also be generated by the propagation of that secondary sound. Note that the information on the conditions of the spatial environment is a part of the spatial information, and is obtained together with the audio signal by the input sound information.

The direction of arrival of the secondary sound includes additional information such as what kind of object caused the reflection in the case of reflected sound, and to what degree the attenuation rate is at the time of reflection. The additional information is included in the direction of arrival of the secondary sound calculated by the input sound information. Stated differently, the additional information is computationally generated and obtained from the sound information.

To summarize the spatial information: it includes the spatial position of the sound source object in the space (three-dimensional sound field) (information about the position of the sound source object), reflection and diffraction characteristics of sound at the sound source object (collectively, information on the conditions of the spatial environment), and additional information such as the size of the three-dimensional sound field. Based on spatial information, route calculator 121 generates secondary sounds that result from reflection or diffraction of the reproduced sound off various sound source objects. It then calculates additional information such as the direction of arrival of these secondary sounds and their volume levels after attenuation caused by the reflection or diffraction. The sound information (input data) includes spatial information in the form of metadata attached to the audio signal, and this spatial information includes, as described above, information other than the audio signal, such as information necessary for positioning the sound source object in the three-dimensional sound field by making the sound three-dimensional, and/or information used to calculate the information necessary for positioning the sound source object in the three-dimensional sound field by making the sound three-dimensional.

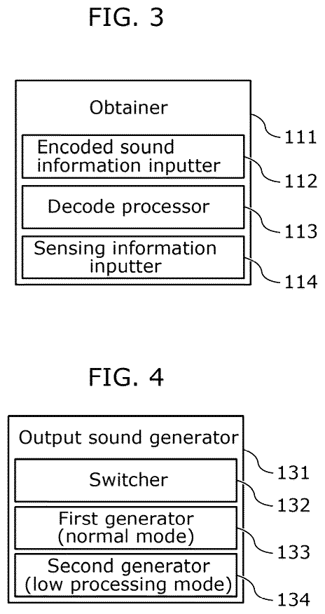

Here, one example of obtainer 111 will be described with reference to FIG. 3. Obtainer 111 is a processor that obtains information necessary for output sound generation. Information necessary for output sound generation includes sound information and a set of head-related transfer functions, sensing information, and the like. FIG. 3 is a block diagram illustrating the functional configuration of an obtainer according to the embodiment. As illustrated in FIG. 3, obtainer 111 according to the present embodiment includes, for example, encoded sound information inputter 112, decode processor 113, and sensing information inputter 114.

Encoded sound information inputter 112 is a processor into which encoded sound information obtained by obtainer 111 is input. The encoded sound information includes, for example, a sound signal encoded in a predetermined format such as MPEG-H 3D Audio (ISO/IEC 23008-3). Encoded sound information inputter 112 outputs the input sound information to decode processor 113. Decode processor 113 is a processor that generates reproduced sound (a sound signal) included in the sound information, a position of the sound source object, and a flag in a format to be used in subsequent processing by decoding the sound information output from encoded sound information inputter 112. Sensing information inputter 114 will be described below along with the function of detector 103.

Note that the processing performed by encoded sound information inputter 112 and decode processor 113 may be executed by a device external to information processing device 101. That is, obtainer 111 only needs to obtain sound information, and may obtain, through communication module 102, sound information that has been decoded by an external device. Although an example in which sound information is encoded has been described, the sound information need not be encoded. For example, the reproduced sound information may be obtained as an unencoded sound signal such as a PCM signal.

The sound signal and spatial information included in the sound information may be obtained from separate streams or files, or may be obtained from the same stream or file.

Obtainer 111 may include a head-related transfer function inputter not illustrated in the figures, and may obtain a set of head-related transfer functions obtained from an external source through communication module 102, and output it to storage 105.

Detector 103 is for detecting the movement speed of the head of user 99. Detector 103 includes a combination of various sensors used for detecting movement, such as a gyro sensor and an acceleration sensor. In the present embodiment, detector 103 is provided in acoustic reproduction system 100, but it may be provided in an external device, such as stereoscopic image reproduction device 300 that operates in response to the movement of the head of user 99, similarly to acoustic reproduction system 100. In such cases, detector 103 need not be included in acoustic reproduction system 100. Detector 103 may be an external imaging device or the like that captures images of the movement of the head of user 99, and the movement of user 99 may be detected by processing the captured images.

Detector 103 is, for example, integrally fixed to the housing of acoustic reproduction system 100, and detects the movement speed of the housing. Acoustic reproduction system 100 including the above-mentioned housing, after being worn by user 99, moves integrally with the head of user 99, and therefore detector 103 can detect the movement speed of the head of user 99.

Detector 103 may, for example, detect a rotation amount with at least one of three mutually orthogonal axes in three-dimensional space as a rotation axis, or detect a displacement amount with at least one of the three axes as a displacement direction, as an amount of movement of the head of user 99. Detector 103 may also detect both the rotation amount and the displacement amount as the amount of movement of the head of user 99.

Sensing information inputter 114 obtains the movement speed of the head of user 99 from detector 103. More specifically, sensing information inputter 114 obtains, as the movement speed, the amount of movement of the head of user 99 detected by detector 103 per unit time. In this way, sensing information inputter 114 obtains at least one of the rotation speed or the displacement speed from detector 103. Here, the amount of movement of the head of user 99 that is obtained is used to determine the position and posture (in other words, the coordinates and orientation) of user 99 in the three-dimensional sound field. Therefore, obtainer 111 also functions as a position obtainer by means of sensing information inputter 114. In acoustic reproduction system 100, sound is reproduced by determining the relative position of the sound image object with respect to user 99 based on the determined coordinates and orientation of user 99. More specifically, the above-mentioned functions are realized by route calculator 121 and output sound generator 131.

Route calculator 121 includes a direction of arrival calculation function that calculates, based on the determined coordinates and orientation of user 99, a relative direction of arrival of the reproduced sound arriving at the position of user 99 from the position of the sound source object, and a synthesized sound calculation function that calculates a propagation route from the sound source object, and calculates (i) a synthesized sound arriving at the position of user 99 by indirect propagation of the reproduced sound according to the calculated propagation route of the reproduced sound and (ii) the direction of arrival of the synthesized sound. Stated differently, route calculator 121 is one example of the direction of arrival calculator.

Route calculator 121 may be realized by any process as long as it can calculate the direction of arrival of the reproduced sound when the reproduced sound reaches the user as direct sound, and calculate the synthesized sound (for example, reflected sound, diffracted sound, and reverberation sound) arriving at the position of user 99 by indirect propagation of the reproduced sound, together with its direction of arrival. Route calculator 121 determines, from which direction in the three-dimensional sound field to cause user 99 to perceive the reproduced sound and synthesized sound as arriving, based on the coordinates and orientation of user 99, and processes the sound information such that, when the output sound signal is reproduced, it is perceived as such a sound.

Output sound generator 131 is a processor that generates an output sound signal by processing information related to reproduced sound included in the sound information.

Here, one example of output sound generator 131 will be described with reference to FIG. 4. FIG. 4 is a block diagram illustrating the functional configuration of an output sound generator according to the embodiment. As illustrated in FIG. 4, output sound generator 131 according to the present embodiment includes, for example, switcher 132, first generator 133, and second generator 134. Switcher 132 is a processor for switching between using first generator 133 or second generator 134 when generating the output sound signal. Therefore, switcher 132 has a function of obtaining information for determining whether to use first generator 133 or second generator 134.

First generator 133 is a processor used when the head-related transfer function is convolved directly with the reproduced sound without applying panning processing. First generator 133 is a processor used when generating the output sound signal in “normal mode”. First generator 133 obtains the reproduced sound and the head-related transfer function corresponding to the direction of arrival of the reproduced sound, performs convolution processing of the obtained head-related transfer function on the reproduced sound, and generates the output sound signal.

Second generator 134 is a processor used when applying panning processing, performing conversion processing to convert the reproduced sound to representative sound, and then convolving the head-related transfer function with the converted representative sound. Second generator 134 is a processor used when generating the output sound signal in “low processing mode”. Second generator 134 obtains the reproduced sound and the position of a representative point, and performs conversion processing to convert the reproduced sound into representative sound that will replicate the reproduced sound as if it were emanating from the representative point.

For example, when a sound source object is positioned between two representative points, sound is generated so that the same sound as the reproduced sound is played from each of the two representative points. Representative sound can be generated by adjusting the gain of the generated sound to correspond to the position of the sound source object. Conversion from reproduced sound to representative sound is not limited to such examples. For example, conversion from reproduced sound to representative sound may be performed by performing time shift adjustment and gain adjustment as will be described later, or any other existing conversion may be used as long as it can perform conversion from reproduced sound to representative sound that will replicate the reproduced sound as if it were emanating from the representative point. An example of conversion that performs time shift adjustment and gain adjustment will be described later. Second generator 134 obtains the same number of representative sounds as the number of representative points obtained by the conversion, and the head-related transfer functions corresponding to the representative directions from each representative point to the position of user 99, performs convolution processing of the obtained head-related transfer functions on the representative sounds, and generates the output sound signal.

We will now refer again to FIG. 2. Output sound generator 131 obtains the head-related transfer function used for generating the output sound signal from storage 105. Storage 105 is an information storage device that serves a dual function, namely, as a memory device for storing information and also as a storage controller that reads out stored information and outputs it to other processors included in the information processing device. Storage 105 may be interpreted as memory included in information processing device 101. Storage 105 stores the head-related transfer function obtained by obtainer 111 for each direction of arrival to user 99. Included in storage 105 is a set of general-purpose head-related transfer functions that can be used for everyone, or a set of head-related transfer functions optimized for user 99 individually, or a set of head-related transfer functions that are publicly available. Storage 105 receives a query from output sound generator 131 specifying the direction of arrival, and outputs the head-related transfer function corresponding to that direction of arrival to output sound generator 131. Output sound generator 131 may also, in response to a query from switcher 132, output all sets of head-related transfer functions or output characteristics of the head-related transfer function set itself. In obtainer 111, the set of head-related transfer functions may be obtained from an external source in, for example, SOFA file format, and subsequently stored in storage 105.

Signal outputter 141 is a functional element that outputs the generated output sound signal to driver 104. Signal outputter 141 generates a waveform signal by performing digital-to-analog signal conversion based on the output sound signal, causes driver 104 to generate sound waves based on the waveform signal, and presents sound to user 99. Driver 104 includes, for example, a diaphragm and a driving mechanism such as a magnet and a voice coil. Driver 104 operates the driving mechanism in accordance with the waveform signal, and causes the diaphragm to vibrate via the driving mechanism. In this way, driver 104 generates sound waves by vibrating the diaphragm in accordance with the output sound signal (meaning to “reproduce” the output sound signal, that is, user 99 perceiving it is not included in the meaning of “reproduction”), the sound waves propagate through the air and are transmitted to user 99's ears, and user 99 perceives the sound.

### Operations

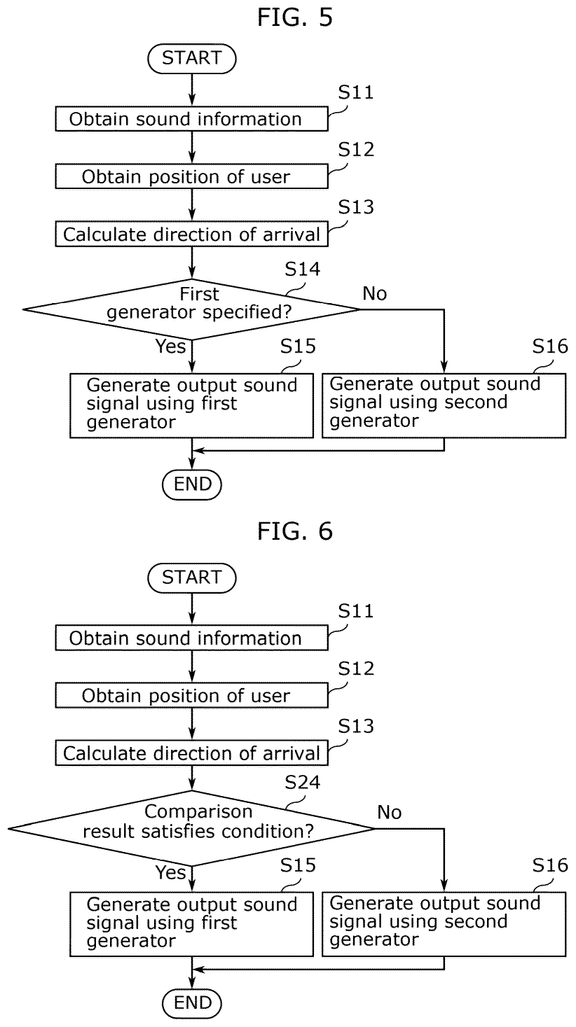

Next, operations performed particularly by information processing device 101 of acoustic reproduction system 100 described above will be explained with reference to FIG. 5 through FIG. 8.

First, FIG. 5 is a flowchart illustrating a first operation example of an information processing device according to the embodiment. In the first operation example of information processing device 101, obtainer 111 obtains sound information via communication module 102 (step S11). The sound information is decoded by decode processor 113 into information related to reproduced sound, information related to the position of the sound source object, and a flag, and generation of the output sound signal is started.

Sensing information inputter 114 obtains information related to the position of user 99 (step S12). Route calculator 121 calculates the direction of arrival for the reproduced sound based on the position of the sound source object and the position of user 99 (step S13). Here, the flag included in the sound information is a flag that is set by the creator when creating the sound information. This flag is moreover a flag for specifying whether to have the output sound signal be generated by first generator 133 or to have the output sound signal be generated by second generator 134. Since the creator knows what kind of sound source objects are included in the original sound information, they can set a flag to have first generator 133 generate the output sound signal when, for example, the sound information contains relatively few sound source objects.

Alternatively, the creator can set a flag to have second generator 134 generate the output sound signal when, for example, the sound information contains relatively many sound source objects. If the flag specifies to have first generator 133 generate the output sound signal, this may be treated as effectively specifying that the output sound signal should not be generated by second generator 134. If the flag specifies to have second generator 134 generate the output sound signal, this may be treated as effectively specifying that the output sound signal should not be generated by first generator 133.

In the operation example of FIG. 5, a determination is made as to whether the flag specifies to use first generator 133 (step S14). If the flag specifies to use first generator 133 (Yes in S14), the output sound signal is generated by first generator 133 (step S15). However, if the flag does not specify to use first generator 133 (No in S14), the output sound signal is generated by second generator 134 (step S16). Note that output sound generator 131 may use switcher 132 to perform the determination of step S14 and switch between having the output sound signal be generated by first generator 133 or having the output sound signal be generated by second generator 134, or a flag determiner not illustrated in the figures may perform the determination of step S14, and obtainer 111 may directly input sound information to first generator 133 or input sound information to second generator 134 in accordance with the determination result. Stated differently, switching between having the output sound signal be generated by first generator 133 or having the output sound signal be generated by second generator 134 is not essential.

Next, FIG. 6 is a flowchart illustrating a second operation example of an information processing device according to the embodiment. In the operation example illustrated in FIG. 6, step S24 is executed instead of step S14, but otherwise it is the same as the operation example illustrated in FIG. 5. Accordingly, repeated explanation will be omitted. In the operation example illustrated in FIG. 6, after step S13, the number of sound source objects included in the sound information is compared with the number of representative points set in the three-dimensional sound field, and depending on whether the comparison result satisfies a predetermined condition, the operation switches between executing step S15 or executing step S16. More specifically, switcher 132 obtains sound information, and counts the number of sound source objects.

Switcher 132 also obtains the number of representative points set in the three-dimensional sound field (the number of representative points is stored as setting information in storage not illustrated in the figures). Switcher 132 compares the number of sound source objects with the number of representative points. Switcher 132 determines whether the comparison result satisfies a predetermined condition based on whether, for example, the number of sound source objects is less than the number of representative points multiplied by a coefficient (step S24). If the predetermined condition is satisfied (if the number of sound source objects is less than the number of representative points multiplied by a coefficient) (Yes in S24), switcher 132 switches so that step S15 is executed. If the predetermined condition is not satisfied (if the number of sound source objects is greater than or equal to the number of representative points multiplied by a coefficient) (No in S24), switcher 132 switches so that step S16 is executed. Here, the coefficient multiplier is set based on the assumption that generating the output sound signal in normal mode is either equal to or more efficient in terms of the amount of processing required compared to generating the output sound signal in low processing mode. As explained above, since panning processing has its own processing load, the coefficient varies within a range from several times such as 1 time, 3 times, 5 times, to several tens of times such as 10 times, 30 times, 50 times, depending on the panning processing that is implemented. Stated differently, an appropriate numerical value may be set as the coefficient according to the type of panning processing being used.

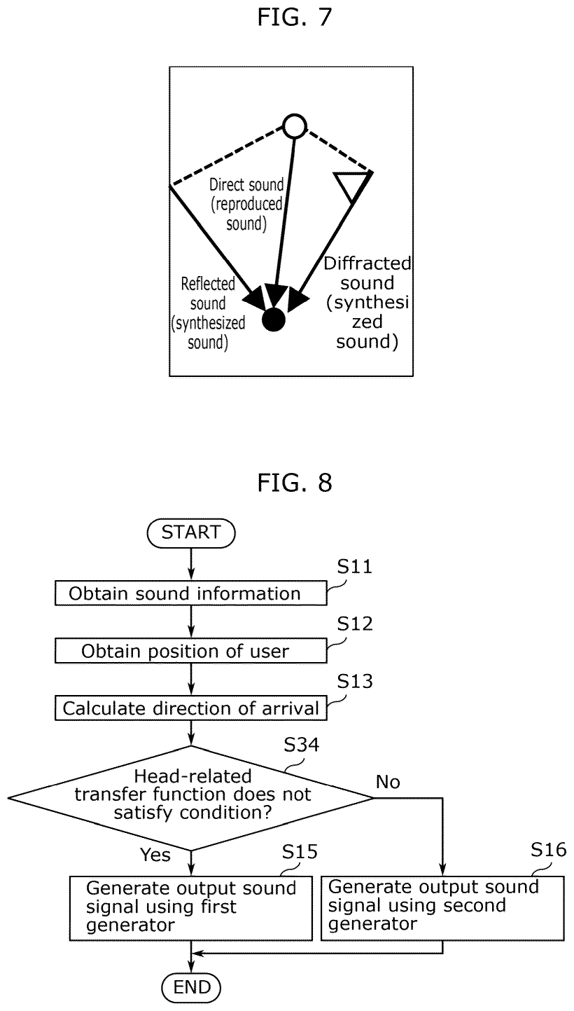

As illustrated in FIG. 7, in a three-dimensional sound field (the outermost rectangle in the figure), when reproduced sound from a sound source object indicated by the white circle arrives at the position of user 99 indicated by the black circle, in addition to direct sound that arrives directly, reflected sound and diffracted sound (influenced by objects in the space indicated by inverted triangles), or reverberation sound (not illustrated), which are generated by indirect propagation, also occur simultaneously. Here, the reproduced sound arrives from all directions due to various forms of indirect propagation, such as sound reflection, diffraction, and reverberation. Therefore, since generating output sound signals directly for the reproduced sound may sound unnatural, in the present embodiment, synthesized sound that simulates the reproduced sound arriving through indirect propagation paths is generated. Such synthesized sound must also be perceived as coming from an appropriate direction of arrival, and must be included in the output sound signal, just like reproduced sounds from the sound source object. Stated differently, a determination should be made whether panning processing is necessary for either a pair consisting of reproduced sound and synthesized sound, or for a pair of synthesized sounds that arrive through different indirect propagation paths. Therefore, returning to FIG. 6, the total number of reproduced sounds and synthesized sounds may be used as the object to be compared with the number of representative points in step S24. In this case as well, the operation switches between executing step S15 or executing step S16 depending on whether a predetermined condition, such as a coefficient multiplier, is satisfied.

Next, FIG. 8 is a flowchart illustrating a third operation example of an information processing device according to the embodiment. In the operation example illustrated in FIG. 8, step S34 is executed instead of step S14, but otherwise it is the same as the operation example illustrated in FIG. 5. Accordingly, repeated explanation will be omitted. In the operation example illustrated in FIG. 8, after step S13, the operation switches between executing step S15 or executing step S16 depending on whether the head-related transfer functions included in storage 105 are sufficiently dense to effectively reduce processing requirements by applying panning processing. More specifically, switcher 132 queries storage 105, and reads out either a set of head-related transfer functions or characteristic information regarding the density of the head-related transfer functions. Switcher 132 then determines whether the head-related transfer functions included in storage 105 are sparse or dense with respect to a predetermined threshold value.

Stated differently, switcher 132 determines whether a predetermined condition is satisfied based on whether the characteristic regarding the density of the head-related transfer functions is denser than a threshold value regarding density (step S34). If the predetermined condition is not satisfied (if the characteristic regarding the density of the head-related transfer function is sparser than the threshold value) (Yes in S34), switcher 132 switches so that step S15 is executed. If the predetermined condition is satisfied (if the characteristic regarding the density of the head-related transfer function is denser than the threshold value) (No in S34), switcher 132 switches so that step S16 is executed. The threshold value for density is set according to whether the head-related transfer function exists at intervals finer than angular increments such as 5, 10, or 15 degrees in either the horizontal direction or the vertical direction, or both. The threshold value for density depends on the direction of arrival of the reproduced sound from the sound source object included in the sound information, and also depends on the representative direction from the preset representative point. Therefore, the threshold value may be appropriately set according to the direction of arrival of the reproduced sound from the sound source object included in the sound information and the representative direction from the representative point.

### Specific Example of Panning Processing

In the panning processing, reproduced sound from a plurality of sound source objects is expressed by representative sound from a plurality of representative directions. For example, it is possible to use two or three directions for these representative directions. More specifically, in the panning processing, the sound source objects are consolidated into representative points fewer in number than the number of sound source objects, and it is possible to make the reproduced sound be perceived as if it were coming from the direction of arrival using only the head-related transfer functions of the representative directions for these representative points. The panning processing may be interpreted as processing that distributes the reproduced sound to representative points (representative directions). More specifically, the sound signal of the reproduced sound associated with the position of each sound source object is distributed to the position of a representative point, and representative sound arriving from the representative point (representative direction) to the listener is generated. Here, the representative direction is a direction determined by the relationship between the head direction of the listener and the position of the representative point. For example, this refers to the direction of the representative point as viewed from the front of the listener. The direction of the representative point may be rephrased as the direction of the representative point when the direction in which the front of the listener's face is facing is used as a reference, or the direction of the representative point as viewed from the listener's eyes.

Here, in the panning processing, a time shift (delay, time delay) that maximizes the cross-correlation between the head-related transfer function of the direction of arrival from the sound source object and the head-related transfer function of the representative direction is calculated. A time-shifted signal in which the time shift obtained here or a time shift with a negative sign added to this obtained time shift applied to the reproduced sound of the sound source object is treated as being in the representative direction, and subsequent processing is performed accordingly.

This time shift may also allow for a time shift shorter than the sampling period (a shift in which the sample position is indicated by a decimal number, hereinafter referred to as a “decimal shift”). This decimal shift can be performed by oversampling.

Here, in the panning processing, a gain is applied to signals of representative directions in which the reproduced sound of the sound source object has been time-shifted, and by calculating the sum of those signals calculated per representative point after convolving them with the head-related transfer functions corresponding to the respective representative points, a signal equivalent to the reproduced sound of the sound source object convolved with the head-related transfer function of the direction of arrival is synthesized.

However, in the panning processing, when synthesizing a head-related transfer function (vector) of the direction of arrival using a sum of head-related transfer functions (vectors) of the representative directions, a gain may be calculated so that an error signal vector between the synthesized head-related transfer function (vector) and the head-related transfer function (vector) of the direction of arrival is orthogonal to each of the head-related transfer functions (vectors) of the representative directions. Note that a head-related transfer function (vector) refers to the time waveform of the head impulse response, which is the representation of the head-related transfer function in the time domain, regarded as a vector. Hereinafter, this head-related transfer function (vector) will also be simply referred to as a head-related transfer function vector.

In the panning processing, regarding this gain, a correction is made so that the energy balance of the head-related transfer functions from the position of the sound source object to the left and right ears of user 99 is maintained even in the head-related transfer function synthesized using head-related transfer functions from a plurality of representative points by the panning processing. Stated differently, in the panning processing, the gain may be corrected so that the energy balance of the head-related transfer functions of the left and right ears of user 99 based on the sound source object is maintained even in the head-related transfer function synthesized by the panning processing.

In the present embodiment, in the panning processing, for each direction of arrival from the sound source object, it is possible to calculate a gain value to be multiplied by the head-related transfer function of the representative direction and a time shift value to be applied to the head-related transfer function of the representative direction, and store them in table data (a head-related transfer function table or adjustment amount table) to be described later.

Based on this, in the panning processing, a time shift is performed on each sound source object using the time shift value and gain value corresponding to the direction of arrival of each sound source object, a gain is applied, and the sum of these is taken as a sum signal. In the panning processing, this sum signal is treated as existing at the position of the representative point. In the panning processing, it is possible to generate a signal at an ear of user 99 by convolving the head-related transfer function of the direction of the representative point with this sum signal.

In the panning processing, a gain may be used that is calculated to minimize energy or L2 norm of an error signal vector between the synthesized HRIR vector and the HRIR vector of the sound source direction. The HRIR vector contains elements that are the sampled values of the time-domain waveform of the head-related transfer function at a sampling frequency of 48 KHz.

In the above, an example has been described in which the head-related transfer function itself is used when calculating the time shift and gain that maximize the cross-correlation. However, the time shift and/or gain values may be derived from a cross-correlation that was calculated after applying a frequency-domain weighting filter.

That is, for the calculation of the time shift and gain values that maximize the cross-correlation, it is possible to use that to which a frequency-domain weighting filter (hereinafter also referred to as a “frequency weighting filter”) has been applied.

This frequency weighting filter is preferably a filter that has a cutoff frequency slightly higher than or near the frequency band where human auditory sensitivity is high, thereby attenuating the higher frequency ranges where human hearing sensitivity diminishes. For example, it is preferable to use a low-pass filter (LPF) with a cutoff frequency of 3000 Hz to 6000 Hz and approximately 6 dB/oct (octave) to 12 dB/oct.

Note that in the panning processing, adjustment amounts for the time shift adjustment and gain adjustment may be determined according to the set of head-related transfer functions included in storage 105, and the reproduced sound may be converted into the representative sound by applying the time shift adjustment and the gain adjustment with the determined adjustment amounts. Since optimal adjustment amounts in the time shift adjustment and gain adjustment used in the panning processing differ depending on the head-related transfer function, first, when obtaining a set of head-related transfer functions such as SOFA files, or when reading out a set of head-related transfer functions included in storage 105, by determining the adjustment amounts in the time shift adjustment and gain adjustment that are tailored to each head-related transfer function included in the set of head-related transfer functions, the same adjustment amounts can be reused as long as this set of head-related transfer functions is used thereafter, which is advantageous from the perspective of processing load. More specifically, when using, for example, three representative directions in the panning processing, first, when obtaining a set of head-related transfer functions (for example, at initialization), a plurality of representative direction candidates (for example, eight directions) are selected from the directions of the full sphere included in the set of head-related transfer functions. Next, for each head-related transfer function of the full sphere included in the set of head-related transfer functions, it is determined which three directions among the plurality of representative direction candidates are to be used as representative directions. Next, for each direction of the full sphere included in the set of head-related transfer functions, adjustment amounts in the time shift adjustment and gain adjustment for distributing signals to the three identified representative directions are calculated. The calculated adjustment amounts are determined as adjustment amounts associated with each direction of the full sphere included in the set of head-related transfer functions.

The head-related transfer function table is one example of table data containing head-related transfer functions that is stored in storage 105. In the head-related transfer function table, adjustment amounts for use in the time shift adjustment and gain adjustment that are determined in accordance with a head-related transfer function are stored in association with the head-related transfer function. Stated differently, for each head-related transfer function included in storage 105, adjustment amounts for the time shift adjustment and gain adjustment may be calculated in advance, and the head-related transfer function table may be constructed in advance. In this manner, head-related transfer function table data that associates each head-related transfer function with the corresponding adjustment amounts may be stored in storage 105. Note that the calculation of adjustment amounts for each head-related transfer function may be performed by second generator 134 or decode processor 113. Alternatively, the calculation of adjustment amounts may be performed by an external device, and may be stored in the memory of the external device. In this case, the memory of the external device corresponds to one example of the storage.

Adjustment amounts for the time shift adjustment and gain adjustment may be calculated in advance for each direction of each of a plurality of head-related transfer functions included in the set of head-related transfer functions, and an adjustment amount table that associates each of a plurality of representative directions with adjustment amounts for each direction of each of the plurality of head-related transfer functions included in the set of head-related transfer functions may be constructed and stored in storage 105. Here, since the plurality of representative directions are (for example, three directions) selected from a plurality of representative direction candidates (for example, eight directions), the adjustment amount table includes information about which representative directions (for example, which three directions) were selected from the plurality of representative direction candidates (for example, eight directions), for each direction of the full sphere included in the set of head-related transfer functions. The adjustment amount table may include table data that associates head-related transfer functions of each of the plurality of representative directions with adjustment amounts for the time shift adjustment and gain adjustment for each direction of each of the plurality of head-related transfer functions included in the set of head-related transfer functions, and the head-related transfer functions of each of the plurality of representative directions may be extracted at the time of rendering or system initialization from the set of head-related transfer functions of the full sphere (plurality of directions) that has been obtained in advance and stored in storage 105. A set of head-related transfer functions may be obtained from an external source at the time of system initialization, and it may be stored in storage 105 after constructing the adjustment amount table at initialization. In such case, the adjustment amount table stored in storage 105 may be read and used during the output processing of the audio signal.

Initialization and output processing according to the present disclosure will be described below.

For example, in the embodiment, the update processing of the spatial information (information update thread) and the output processing of the audio signal added with acoustic processing (audio thread) may be executed in a single thread, or may be executed in different threads. When executing these two processes in different threads, the activation frequency of the threads may be set individually, or the processing may be executed in parallel.

In particular, when executing these two processes in different independent threads, it is possible to preferentially allocate computational resources to the output processing of the audio signal added with acoustic processing. This makes it possible to safely execute sound output processing where even slight delays cannot be tolerated, for example, sound output processing where a popping noise occurs with a delay of one sample (0.02 msec).

In this case, allocation of computational resources to the spatial information update process is restricted. However, the update of the spatial information is a low-frequency process (for example, a process such as updating the direction of the listener's face) compared to the output processing of the audio signal, and therefore does not necessarily need to be performed in approximately real time without delay like the output processing of the audio signal. Therefore, even if allocation of computational resources is restricted, there is no significant impact on the acoustic quality.

The update of the spatial information may be executed periodically at predetermined times or intervals, or may be executed when a predetermined condition is met. The update of the spatial information may be executed manually by the listener or the manager of the sound space, or may be triggered by changes in an external system.

For example, the spatial information may be updated when a controller is operated by the listener to cause the listener's own avatar's position to instantly warp, or cause time to be rapidly advanced or rewound. Alternatively, the spatial information may be updated when an effect that suddenly changes the environment of the scene is applied by the manager of the virtual space. In these cases, the thread for updating the spatial information may be activated as a one-time interrupt process in addition to periodic activation.

For example, the update processing of the spatial information may be performed at the time of creating the virtual space (at the time of creating the software), at the time of loading the information (scene information) of the virtual space, at the time of starting the processing of the virtual space (at the time of starting the software or starting rendering), or at the timing when an information update thread that periodically occurs in the processing of the virtual space has occurred. The virtual space can be created at different times: it may be constructed before acoustic processing begins, when spatial information about the virtual space is obtained, or when the relevant software is obtained.

Thus, in the present disclosure, there exist three processing threads (in other words, workflows) that occur at different frequencies: processing threads that occur irregularly, processing threads that occur periodically at low frequency such as updates to the orientation of the listener's face, and processing threads that occur periodically at high frequency such as sound output processing. The processing at the time of initialization in the present disclosure corresponds to the processing thread that occurs irregularly among those described above.

The adjustment amount table may be a table that includes, for a sound signal arriving at the position of the listener from the direction of each head-related transfer function of the set of head-related transfer functions of the full sphere, information on which representative direction among the plurality of representative directions to distribute that signal to, and information on time shift adjustment amounts and gain adjustment amounts to be multiplied by the audio signal for each representative direction when distributing.

When performing the convolution processing of the head-related transfer function, by referencing the adjustment amount table stored in storage 105 and using the adjustment amounts for time shift adjustment and gain adjustment associated with the head-related transfer function for the direction to be applied, the overall processing load can be reduced since it is not necessary to calculate the adjustment amounts for each convolution processing.

It should be noted that the embodiment of the present invention can also be applied to a new set of head-related transfer functions (for example, SOFA file) that is not included in storage 105. When decoding the sound signal, at power-on of acoustic reproduction system 100, or at initialization of acoustic reproduction system 100, the head-related transfer functions for the entire three-dimensional sound field may be newly loaded, and the representative directions may be determined again using the method disclosed in the present embodiment or another method, and calculation of adjustment amounts for each head-related transfer function included in the new set of head-related transfer functions may be performed. In this case, table data that associates the head-related transfer function with the corresponding adjustment amounts may be stored in storage 105. Alternatively, the calculation of adjustment amounts may be performed by an external device, and may be stored in the memory of the external device. When performing the convolution processing of the head-related transfer function, by referencing the adjustment amounts for time shift adjustment and gain adjustment associated with the head-related transfer function to be applied, the overall processing load can be reduced since it is not necessary to calculate the adjustment amounts for each convolution processing.

In this manner, when a new set of head-related transfer functions that is not stored in storage 105 is loaded, adjustment amounts for the time shift adjustment and gain adjustment to be used in the panning processing may be determined for the new set of head-related transfer functions before storing it in storage 105, a head-related transfer function table may be constructed by associating the new set of head-related transfer functions with the determined adjustment amounts, and stored in storage 105. When performing the panning processing, these adjustment amounts are read from storage 105, and the time shift adjustment and gain adjustment are applied according to the read adjustment amounts. Note that the new head-related transfer function may be one that was previously stored in storage 105 and temporarily removed from storage 105 when decoding the sound signal, at power-on of acoustic reproduction system 100, or at initialization of acoustic reproduction system 100, and then stored again in storage 105. Alternatively, table data for a new set of head-related transfer functions and each of the table data that was previously stored in storage 105 may be stored in storage 105 as table data corresponding to different sets of head-related transfer functions. Note that the table data stored in storage 105 here may be a head-related transfer function table, or it goes without saying that it may be an adjustment amount table that is a part of the head-related transfer function table. Such determination of adjustment amounts is effective even without switching whether to perform panning processing. Stated differently, instead of first generator 133 and second generator 134, a third generator distinct from first generator 133 and second generator 134 may be included that applies the time shift adjustment and the gain adjustment to the reproduced sound using the adjustment amounts associated with the new head-related transfer function stored in storage 105 to convert it into representative sound, and generates the output sound signal by convolving the head-related transfer functions corresponding to the representative directions from the positions of each of representative points toward the position of the user onto the representative sound.

### OTHER EMBODIMENTS

While exemplary embodiments have been described above, the present disclosure is not limited to the above-described embodiments.

For example, the acoustic reproduction system described in the above embodiments may be implemented as a single device including all elements, or may be implemented by a plurality of devices, with each function allocated to the devices and these devices cooperating with each other. In the latter case, an information processing device such as a smartphone, tablet terminal, or personal computer (PC) may be used as a device corresponding to the information processing device. For example, in acoustic reproduction system 100 having a function as a renderer that generates an acoustic signal added with an acoustic effect, a server may handle all or part of the functions of the renderer. Stated differently, all or part of obtainer 111, route calculator 121, output sound generator 131, and signal outputter 141 may be implemented in a server not shown in the figure. In such case, acoustic reproduction system 100 is implemented by combining an information processing device such as a computer or smartphone, an audio presentation device such as a head-mounted display (HMD) or earphones worn by user 99, and a server not illustrated in the figures. Note that the computer, audio presentation device, and server may be communicably connected on the same network or may be connected on different networks. When connected on different networks, the possibility of communication delays increases, so a configuration may be adopted in which processing on the server is permitted only when the computer, audio presentation device, and server are communicably connected on the same network. Based on the amount of data in the bitstream received by acoustic reproduction system 100, a configuration in which whether or not all or part of the renderer's functions are to be handled by the server is determined may be implemented.

The acoustic reproduction system according to the present disclosure can also be implemented as an information processing device that is connected to a reproduction device including only drivers, and that only reproduces output sound signals generated based on obtained sound information for the reproduction device. In such cases, the information processing device may be implemented as hardware including dedicated circuits, or may be implemented as software for causing a general-purpose processor to execute specific processing.

In the above embodiments, processing executed by a specific processor may be executed by another processor. The order of a plurality of processes may be changed, and a plurality of processes may be executed in parallel.

Moreover, in the above embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each of the structural elements may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as an audio signal reproduction method executed by a computer, or may be implemented as a program for causing a computer to execute an audio signal reproduction method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

Note that the encoded sound information in the present disclosure can be rephrased as a bitstream including a sound signal, which is information about a predetermined sound reproduced by acoustic reproduction system 100, and metadata, which is information about a localization position when localizing the sound image of the predetermined sound at a predetermined position in a three-dimensional sound field. For example, the sound information may be obtained by acoustic reproduction system 100 as a bitstream encoded in a predetermined format such as MPEG-H 3D Audio (ISO/IEC 23008-3). As one example, the encoded sound signal includes information about a predetermined sound that is reproduced by acoustic reproduction system 100. Here, the predetermined sound is a sound emitted by a sound source object existing in the three-dimensional sound field or an environmental sound, and can include, for example, mechanical sounds, or voices of animals including humans. Note that when there are a plurality of sound source objects in the three-dimensional sound field, acoustic reproduction system 100 obtains a plurality of sound signals respectively corresponding to the plurality of sound source objects.

Metadata is, for example, information used for controlling acoustic processing on the sound signal in acoustic reproduction system 100. The metadata may be information used for describing a scene expressed in the virtual space (three-dimensional sound field). Here, the term “scene” refers to an aggregate of all elements representing three-dimensional images and acoustic events in the virtual space, which are modeled in acoustic reproduction system 100 using metadata. Thus, metadata herein may include not only information for controlling acoustic processing, but also information for controlling video processing. The metadata may of course include information for controlling only acoustic processing or video processing, or may include information for use in controlling both. In the present disclosure, the bitstream obtained by acoustic reproduction system 100 may include such metadata. Alternatively, acoustic reproduction system 100 may obtain metadata separately from the bitstream, as described later.

Acoustic reproduction system 100 generates virtual acoustic effects by performing acoustic processing on the sound signal using metadata included in the bitstream and additionally obtained interactive position information of user 99. For example, acoustic effects such as early reflected sound generation, late reverberation sound generation, diffracted sound generation, distance attenuation effect, localization, sound image localization processing, or Doppler effect may be added. Information for switching on or off all or part of the acoustic effects may be added as metadata.

Note that the entire metadata or part of the metadata may be obtained from somewhere other than a bitstream that includes sound information. For example, metadata for controlling an acoustic sound or metadata for controlling a video may be obtained from somewhere other than from a bitstream or both may be obtained from somewhere other than from a bitstream.

When metadata for controlling video is included in the bitstream obtained by acoustic reproduction system 100, acoustic reproduction system 100 may include a function to output metadata that can be used for controlling video to a display device that displays images, or to a stereoscopic image reproduction device that reproduces stereoscopic images.

As an example, encoded metadata includes information about a three-dimensional sound field including a sound source object that emits sound and an obstacle object and information about a localization position when the sound image of the sound is localized at a predetermined position in the three-dimensional sound field (i.e., the sound is perceived as arriving from a predetermined direction), namely, information about the predetermined direction. Here, an obstacle object is an object that can affect the sound perceived by user 99, for example, by blocking or reflecting the sound, during the period until the sound emitted by the sound source object reaches user 99. Obstacle objects can include not only stationary objects but also animals such as humans or mobile bodies such as machines. When there are a plurality of sound source objects in the three-dimensional sound field, for any given sound source object, the other sound source objects can become obstacle objects. Non-emitting sound source objects such as building material and inanimate objects and sound emitting sound source objects can both be obstacle objects.

The metadata may include, as spatial information including the metadata, not only the shape of the three-dimensional sound field, but also information representing the shape and position of obstacle objects existing in the three-dimensional sound field, and the shape and position of sound source objects existing in the three-dimensional sound field. The three-dimensional sound field may be either a closed space or an open space, and the metadata includes, for example, information representing the reflectivity of structures that can reflect sound in the three-dimensional sound field, such as floors, walls, or ceilings, and the reflectivity of obstacle objects present in the three-dimensional sound field. As used herein, reflectance is the ratio of energy of reflected sound to incident sound, and is set for each frequency band of the sound. The reflectance may be set uniformly regardless of the frequency band of the sound. If the three-dimensional sound field is an open space, parameters such as a uniformly set attenuation rate, diffracted sound, or early reflected sound may be used.

In the above description, reflectance is stated as a parameter with regard to an obstacle object or a sound source object included in metadata, but the metadata may include information other than reflectance. For example, information on the material of an object may be included as metadata related to both of a sound source object and a non-emitting sound source object. Specifically, metadata may include a parameter such as a diffusion factor, a transmittance, or an acoustic absorptivity.

Information related to the sound source object may include loudness, radiation characteristics (directivity), reproduction conditions, the number and types of sound sources emitted from a single object, or information specifying the sound source region in the object. The reproduction condition may determine that a sound is, for example, a sound that is continuously being emitted or is emitted at an event. The sound source region in the object may be determined based on the relative relationship between the position of user 99 and the position of the object, or may be determined with reference to the object. When determined based on the relative relationship between the position of user 99 and the position of the object, with respect to the plane along which user 99 is looking at the object, user 99 can be made to perceive that sound X is emitted from the right side of the object and sound Y is emitted from the left side of the object as seen from user 99. When determined with reference to the object, regardless of the direction in which user 99 is looking, it is possible to fixate which sound is emitted from which region of the object. For example, user 99 can be made to perceive that a high-pitched sound is emitted from the right side and a low-pitched sound is emitted from the left side when viewing the object from the front. In this case, when user 99 moves around to the back of the object, user 99 can be made to perceive that a low-pitched sound is emitted from the right side and a high-pitched sound is emitted from the left side as seen from the back.

The time until an initial reflected sound arrives, the reverberation time, or the ratio between the direct sound and the diffused sound, for instance, can be included as metadata related to a space. When the ratio between the direct sound and the diffused sound is zero, user 99 can be made to perceive only the direct sound.

Information indicating the position and orientation of user 99 in the three-dimensional sound field may be included in the bitstream as metadata as an initial setting, or may not be included in the bitstream. When information indicating the position and orientation of user 99 is not included in the bitstream, information indicating the position and orientation of user 99 is obtained from information other than the bitstream. For example, regarding position information of user 99 in a VR space, the position information may be obtained from an application providing VR content. Regarding position information of user 99 for presenting sound as AR, position information obtained by performing self-position estimation using GPS, a camera, or Laser Imaging Detection and Ranging (LIDAR) on the mobile terminal, for example, may be used. Note that the sound signal and metadata may be stored in a single bitstream or may be separately stored in a plurality of bitstreams. Similarly, the sound signal and metadata may be stored in a single file or may be separately stored in a plurality of files.

When the sound signal and metadata are separately stored in a plurality of bitstreams, information indicating other relevant bitstreams may be included in one or some of the plurality of bitstreams in which the sound signal and metadata are stored. Information indicating other relevant bitstreams may be included in the metadata or control information of each bitstream of the plurality of bitstreams in which the sound signal and metadata are stored. When the sound signal and metadata are separately stored in a plurality of files, information indicating other relevant bitstreams or files may be included in one or some of the plurality of files in which the sound signal and metadata are stored. Information indicating other relevant bitstreams or files may be included in the metadata or control information of each bitstream of the plurality of bitstreams in which the sound signal and metadata are stored.

Here, the related bitstream or the related file is a bitstream or a file that may be simultaneously used in acoustic processing, for example. Information indicating other relevant bitstreams may be collectively described in the metadata or control information of one bitstream of the plurality of bitstreams in which the sound signal and metadata are stored, or may be separately described in the metadata or control information of two or more bitstreams of the plurality of bitstreams in which the sound signal and metadata are stored. Similarly, information indicating other relevant bitstreams or files may be collectively described in the metadata or control information of one file of the plurality of files in which the sound signal and metadata are stored, or may be separately described in the metadata or control information of two or more files of the plurality of files in which the sound signal and metadata are stored. A control file that collectively information indicating describes other relevant bitstreams or files may be generated separately from the plurality of files in which the sound signal and metadata are stored. In such cases, the control file need not store the sound signal and metadata.

Here, information indicating a relevant other bitstream or file may be an identifier indicating the other bitstream, a file name showing the other file, a uniform resource locator (URL), or a uniform resource identifier (URI), for instance. In this case, obtainer 111 identifies or obtains a bitstream or a file, based on information indicating a relevant other bitstream or file. Information indicating other relevant bitstreams may be included in the metadata or control information of at least some of the plurality of bitstreams in which the sound signal and metadata are stored, and information indicating other relevant files may be included in the metadata or control information of at least some of the plurality of files in which the sound signal and metadata are stored. Here, a file that includes information indicating a relevant bitstream or file may be a control file such as a manifest file for use in distributing content, for example.

### INDUSTRIAL APPLICABILITY

The present disclosure is useful for acoustic reproduction, such as making a user perceive three-dimensional sound.

1. An information processing device comprising:
an obtainer that obtains sound information including an audio signal and information on a position of a sound source object in a three-dimensional sound field;
a first generator that generates an output sound signal using (i) a head-related transfer function corresponding to a direction of arrival and (ii) the audio signal, the direction of arrival being based on the position of the sound source object and a position of a user in the three-dimensional sound field; and
a second generator that generates an output sound signal using (i) a head-related transfer function corresponding to a representative direction and (ii) the audio signal, the representative direction being based on a position of a representative point set in the three-dimensional sound field and the position of the user.

2. The information processing device according to claim 1, wherein
the first generator generates the output sound signal by convolving the head-related transfer function corresponding to the direction of arrival with reproduced sound emitted from the sound source object based on the audio signal, and
the second generator generates the output sound signal by performing conversion processing that converts the reproduced sound into representative sound arriving from the representative point, and convolving the head-related transfer function corresponding to the representative direction.

3. The information processing device according to claim 2, wherein
in the conversion processing, the reproduced sound is converted into the representative sound by applying time shift adjustment and gain adjustment to the reproduced sound.

4. The information processing device according to claim 3, wherein
in the time shift adjustment in the conversion processing, one of the following is applied to the reproduced sound:
a time shift calculated to maximize a cross-correlation between the head-related transfer function corresponding to the direction of arrival and the head-related transfer function corresponding to the representative direction; or
a time shift with a negative sign added to the time shift calculated.

5. The information processing device according to claim 4, wherein
in the conversion processing, at least one of the time shift adjustment or the gain adjustment applies a time shift calculated to maximize the cross-correlation after applying a frequency-domain weighting filter, or a time shift with a negative sign added to the time shift calculated.

6. The information processing device according to claim 4, wherein
the representative point and the representative direction respectively comprise a plurality of representative points and a plurality of representative directions, and
in the conversion processing, for each of two or more of the plurality of representative points, a gain that is set for the reproduced sound and for each of the plurality of representative directions is applied to the reproduced sound applied with the time shift.

7. The information processing device according to claim 6, wherein
in the conversion processing, when synthesizing a head-related transfer function vector corresponding to the direction of arrival using a sum of head-related transfer function vectors corresponding to the plurality of representative directions, a gain is used that is so calculated that an error signal vector between the head-related transfer function vector synthesized and the head-related transfer function vector corresponding to the direction of arrival is orthogonal to the head-related transfer function vectors corresponding to the plurality of representative directions.

8. The information processing device according to claim 6, wherein
in the conversion processing, a gain is used that is calculated to minimize energy or L2 norm of an error signal vector between a synthesized head-related transfer function vector and a head-related transfer function vector corresponding to the direction of arrival.

9. The information processing device according to claim 8, wherein
the error signal vector is one to which a frequency-domain weighting filter has been applied.

10. The information processing device according to claim 3, wherein
the information processing device stores an adjustment amount table into storage at initialization, the adjustment amount table associating, for each head-related transfer function direction, a head-related transfer function of a representative direction with adjustment amounts for the time shift adjustment and the gain adjustment to be used in the conversion processing, and
in the conversion processing, the reproduced sound is converted into the representative sound by applying the time shift adjustment and the gain adjustment to the reproduced sound using, from the adjustment amount table stored in the storage, the adjustment amounts associated with each head-related transfer function direction corresponding to the representative direction.

11. The information processing device according to claim 10, wherein
at the initialization, the information processing device determines a plurality of representative directions each of which is the representative direction, and
the adjustment amount table is created based on head-related transfer functions of the plurality of representative directions determined.

12. The information processing device according to claim 1, wherein
the sound information includes a flag that specifies whether to generate the output sound signal using the first generator or to generate the output sound signal using the second generator, and
the information processing device generates the output sound signal using one of the first generator or the second generator that is specified by the flag included in the sound information obtained.

13. The information processing device according to claim 1, further comprising:
a switcher that switches between generating the output sound signal using the first generator or generating the output sound signal using the second generator.

14. The information processing device according to claim 1, further comprising:
a route calculator that calculates a propagation route of reproduced sound emitted from the sound source object based on the audio signal, and calculates (i) a synthesized sound arriving at the position of the user by indirect propagation of the reproduced sound according to the propagation route of the reproduced sound calculated, and (ii) a direction of arrival of the synthesized sound.

15. An information processing method executed by a computer, the information processing method generating an output sound signal as a sound arriving from a sound source object in a virtual three-dimensional sound field by processing sound information, the information processing method comprising:
obtaining a position of the sound source object and an audio signal including reproduced sound emitted from the sound source object based on the audio signal;
obtaining a position of a user in the three-dimensional sound field;
calculating a direction of arrival of the reproduced sound arriving at the position of the user from the position of the sound source object;
generating the output sound signal using (i) a head-related transfer function corresponding to the direction of arrival calculated and (ii) the reproduced sound; and
generating the output sound signal using (i) a head-related transfer function corresponding to a representative direction and (ii) the audio signal, the representative direction being based on a position of a representative point set in the three-dimensional sound field and the position of the user.

16. A non-transitory computer-readable recording medium for use in a computer, the recording medium having a computer program recorded thereon for causing the computer to execute the information processing method according to claim 15.

17. An information processing device comprising:
storage that stores a time shift adjustment amount and a gain adjustment amount in association with each of a plurality of directions;
an obtainer that obtains an audio signal and information on a position of a sound source object in a three-dimensional sound field; and
a second generator that generates an output sound signal as sound arriving at a position of a user in the three-dimensional sound field from a second direction, using (i) the audio signal and (ii) the time shift adjustment amount and the gain adjustment amount corresponding to a first direction based on the position of the sound source object and the position of the user.

18. The information processing device according to claim 17, wherein
the storage further stores a head-related transfer function corresponding to the second direction, and
the second generator generates the output sound signal as sound arriving at the position of the user from the second direction using (i) the audio signal, (ii) the time shift adjustment amount and the gain adjustment amount corresponding to the first direction, and (iii) the head-related transfer function corresponding to the second direction.

19. The information processing device according to claim 17, wherein
the storage further stores a head-related transfer function corresponding to the second direction and head-related transfer functions corresponding to directions other than the second direction,
the second generator generates the output sound signal as sound arriving at the position of the user from the second direction using (i) the audio signal, (ii) the time shift adjustment amount and the gain adjustment amount corresponding to the first direction, and (iii) the head-related transfer function corresponding to the second direction,
the information processing device further comprises a first generator, and
the first generator generates an audio signal as sound arriving at the position of the user from the first direction using (i) the audio signal and (ii) a head-related transfer function corresponding to the first direction.
